(19) United States
(12) Patent Application Publication
(10) Pub. No.: US 2024/0321267 A1
(43) Pub. Date: Sep. 26, 2024

(54) A SYSTEM AND METHOD FOR DELIVERING DOMAIN OR USE-CASE SWITCH SUGGESTION FOR AN ONGOING CONVERSATION

(71) Applicant: HISHAB INDIA PRIVATE LIMITED, New Delhi (IN)

(72) Inventors: Christopher VOIGT, Saarbrucken (DE); Alam Aseequl KHAN, Dhaka (BD); Kai Samuel David Erik KARREN, Saarbrucken (DE); Michael SCHMITS, Saarbrucken (DE); Mohammad Fayadan HOSSAIN, Dhaka (BD)

(21) Appl. No.: 18/573,542

(22) PCT Filed: Jun. 23, 2022
(86) PCT No.: PCT/JP2022/025199

§ 371 Date: Dec. 22, 2023

(30) Foreign Application Priority Data
Jun. 23, 2021 (BD) P/BD/2021/000192

(51) Int. Cl. G10L 15/18; G10L 15/22; G10L 25/93

(52) U.S. Cl. CPC G10L 15/1815; G10L 15/22; G10L 25/93

(57) ABSTRACT

A system and method are described for dialogue management by determining a transition from a domain or a use case to another and initiating a switch suggestion in a human-computer conversation for rendering services to a user based on the updated domain or use case for a dialogue. The method comprises determining a first use-case in the human-computer conversation and assigning a first use-case score to the said first use-case. The method then comprises determining a second use-case in the human-computer conversation and assigning a second use-case score to the said second use-case. Further, the method comprises determining whether to make the use-case switch suggestion to the said second use-case based on the said first use-case score and the said second use-case score. The invention aligns the system to extract intended information from/for the user thereby making the system more efficient, approachable and user-friendly by saving time and cost.

### TECHNICAL FIELD

The present invention generally relates to a system and a method for dialogue management and more particularly, the present invention relates to determining a transition from a use case and rendering services to a user based on the updated use case for a dialogue between the user and the system.

### BACKGROUND ART

The field of man-machine interaction has seen some significant improvements in the past few years with new breakthroughs in the artificial intelligence sector, creating a fundamental impact thereby transforming all sectors of the economy. With an increasing number of online services, for example customer service, management of information involving tasks of retrieving a particular information from a vast amount of data, various systems are configured to assist a user in performing their tasks. There are various modes through which the system enables a user to retrieve the information as desired by the user through various services. These services often include specialized agents, which operate usually in association with the organizations they belong to and are designed for performing various functions. These agents are either human agents or dialogue managers within a system. Over the time, usage of dialogue managers have been increasing which provide a similar service to the users as provided by the human agents. However, dialogue managers have their limitations and it is expected that these dialogue managers could also engage in dialogue with the users in order to perform the tasks with efficiency as any human agent would do.

With users being increasingly able to interact with dialogue managers in natural language conversations, the existing dialogue managers have often encountered difficulties handling interruptions, cancellations and switching between use cases and domains in an ongoing conversation.

A domain may represent a specific content area of the relevant conversation between a user and the dialogue manager. Examples of domain include, but not limited to, search, banking, shopping, movie, music, restaurant, flights, call center etc.

A use-case may represent the interactions and activities associated with the domain to satisfy an intent. For the present invention, the goal of a use case is to convey the most important aspects of the user-system interaction by focusing on the user's intent. Examples of use-cases include, but are not limited to, in an active domain of banking, activities and interactions between a user and the dialogue manager corresponding to transferring money to an account, paying off credit card debt, or updating credentials etc.

An intent represents the action or purpose the user wishes to accomplish through participating in a conversation with the dialogue manager. Examples of intents include, but are not limited to user requests to initiate actions, find content, start over a process, go back, find information, etc. An example of an intent to initiate an action includes, a user making a request to transfer money from his/her account within a corresponding use-case.

For example, in a scenario where a user and a dialogue manager are interacting with each other conversing on a specific use case within a domain (e.g., inquiring account balance) and in the middle of the conversation, the user shifts the conversation towards another use case (e.g., updating account holder's information). As a result, the dialogue manager may not be instantly able to recognize and smoothly handle the switch of the use case. The dialogue manager may require additional information to anticipate and be responsive to the user's transition. The user may then further wish to shift to an entirely different domain (e.g., bicycle configurators) and the dialogue manager may find it difficult to follow with accuracy.

Currently there are limitations for a dialogue manager to recognize a user's misalignment with a running use case or a domain based on analyzing an ongoing conversation. Due to this, a system cannot reduce its uncertainty and/or confusion about a user's input and the system may provide an output that is possibly not in alignment with the intended use case. Consequently, the user may not find the interface user-friendly and be reluctant to use it in the future, as the user feels bound to the use cases and domain he or she does not want to follow.

### SUMMARY OF INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Embodiments of the present invention are directed to a method and a system for dialogue management in a human-computer conversation by determining a transition of a domain or a use case and initiating a domain or use-case switch suggestion to a user. The switch suggestion method comprises determining a first domain or a use case in the human-computer conversation and assigning the first domain or use case a first confidence score.

The switch suggestion method then comprises determining a second domain or a use case in the human-computer conversation and assigning the second domain or use case a second confidence score. Further, the switch suggestion method comprises determining whether to make the domain or use case switch suggestion to the said second domain or use case based on the said first confidence score and the said second confidence score.

As a result, this invention can be used to measure and reduce the uncertainty or confusion surrounding a user's input that is possibly not in alignment with an intended use case in a system. The user (who does not want to break a use case activity/or does not know about the possibility) gets asked by the system if he/she wants to follow a given use case when the system is uncertain, thereby aligning the system to extract intended information from/for the user. As a result, reducing domain or use-case detection ambiguity. This makes the interface more efficient, approachable and user-friendly. Moreover, it saves time and cost for both the system operations and the user usage.

### BRIEF DESCRIPTION OF DRAWINGS

FIG. 1A is a block diagram illustrating data flow between a user and a system for determining a use-case switch suggestion.

FIG. 1B is a block diagram illustrating data flow between a user and a system for determining a use-case switch suggestion excluding an audio feature extractor.

FIG. 1C is a Venn diagram illustrating various levels the system is capable of switching between.

FIG. 2 is a detailed block diagram illustrating an exemplary switch suggestion module.

FIG. 3 is a flowchart illustrating a computing system configured to score a single use-case in a human-computer conversation.

FIG. 4 is a flowchart illustrating a computing system configured to score a plurality of use-cases in a human-computer conversation.

FIG. 5 is a flowchart illustrating an exemplary scenario for a user triggered use-case switch and a system triggered use-case switch.

FIG. 6 is a flowchart illustrating an exemplary scenario for a system triggered use-case switch.

### DETAILED DESCRIPTION OF THE INVENTION

Described herein are systems and methods for determining a domain or a use case switch suggestion in a human-computer conversation. The systems and methods are described with respect to figures and such figures are intended to be illustrative rather than limiting to facilitate explanation of the exemplary systems and methods according to embodiments of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

As used herein, the term “network” refers to any form of a communication network that carries data and is used to connect communication devices (e.g. phones, smartphones, computers, servers) with each other. According to an embodiment of the present invention, the data includes at least one of the processed and unprocessed data. Such data includes data which is obtained through automated data processing, manual data processing or unprocessed data.

As used herein, the term “artificial intelligence” refers to a set of executable instructions stored on a server and generated using machine learning techniques.

As used herein, the term “communication control module” refers to an electronic device, the electronic device comprising a processor and the electronic device is capable of being connected to other electronic/computing devices, displays, sensors over a network.

Although the following description uses terms “first,” “second,” etc. to describe various elements, these elements should not be limited by the terms. These terms are only used to distinguish one element from another. For example, a first intent could be termed a second intent, and, similarly, a second intent could be termed a first intent, without departing from the scope of the various described examples.

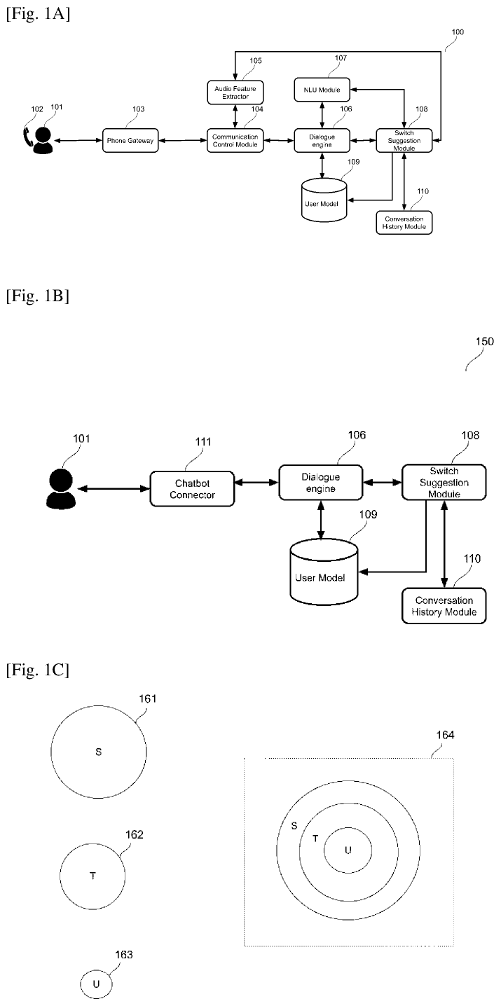

FIG. 1A illustrates a conceptual diagram illustrating an example framework for data flow between a human and an exemplary computer communication system 100 for determining a switch suggestion, in accordance with one or more aspects of the present invention. In this example, the disclosed system includes a communication control module 104, an audio feature extractor 105, a dialogue engine 106, a Natural Language Understanding module 107 (referred to as NLU module 107 hereafter), a switch suggestion module 108, a user model 109, and a conversation history module 110.

Referring back to FIG. 1A, a user 101 initiates a call to system 100 using client device 102. The call is transmitted over phone gateway 103 of a telecom operator network and further routed to the communication control module 104. The client device 102 corresponds to a wide variety of electronic devices. According to an embodiment of the present invention, the client device 102 is a smartphone or a feature phone or any telecommunication device such as an ordinary landline phone. Client device 102 acts as a service request means for inputting a user request.

The user 101 uses client device 102 over the call to input service requests such as, to receive information, and initiate various processes that may be a part of the service requests etc. Communication control module 104 provides a plurality of communication links for managing the overall functioning of system 100 and acts as an entry point for user 101 into system 100. The calls received by communication control module 104, are further routed to the dialogue Engine 106. Dialogue engine 106 then receives the user's conversational input.

Communication control module 104 further connects to audio feature extractor 105 and dialogue engine 106.

When the phone gateway 103 receives a phone call over a telephony network, phone gateway 103 converts the conversation, with user 101 when inputting a request for example, into a digital audio file/stream that is transmittable over a data network and is received by communication control module 104. Communication control module 104 controls and routes the incoming and outgoing audio to audio feature extractor 105 and dialogue engine 106. Audio feature extractor 105 is capable of receiving and listening the audio and dialogue engine 106 is capable of converting the audio into machine readable text utilizing one or methods including Automated Speech Recognition (ASR). The communication control module 104 may convert the audio signals received from the user 101 into a digital format for further processing e.g. an audio file. The communication control module 104 is further capable of detecting voice activation and also detecting end/start-of-speech in a conversation. Audio feature extractor 105 is configured to receive the audio data inputs in real-time transmitted from the communication control module 104. Upon receiving the audio data input from communication control module 104, audio feature extractor 105 is further configured to extract one or more predetermined audio features from the audio data. Audio features may include for example, pitch, waveform etc. that may be required by switch suggestion module 108 for further speech processing.

Communication control module 104 is also capable of receiving the extracted audio features from audio feature extractor 105. Communication control module then transmits the extracted audio features to the dialogue engine 106. The dialogue engine 106 and NLU module 107 then employ one or many techniques for further processing and also, further transmitting the extracted audio features to switch suggestion module 108.

In yet another embodiment of the present invention, the audio feature extractor 105 may be excluded. FIG. 1B illustrates a conceptual diagram illustrating an example framework system 150 for one such embodiment. For illustration purposes only, in this embodiment, a chatbot connector 111 sends and receives textual data from a chatbot app/webpage on the client device 102 to/from the dialogue engine 106. The chatbot connector 111 may be for example, a communication platform that connects the user 101 to dialogue engine 106.

Referring back to FIG. 1A, when the user 101 uses client device 102 to input voice for a service request to the dialogue engine 106, the input voice of the user is processed using a method and system for speech to text translation of the incoming voice of the user. In this example, artificial intelligence techniques are employed to collect data from several users or an individual user to extract key terms indicative of user preferences.

Dialogue engine 106 provides a user interface between the user and the services mainly by engaging in a natural language dialogue with the user. The dialogue may include questions requesting one or more aspects of a specific service, such as asking for information. In this manner system 100 may also receive general conversational queries and engage in a continuous conversation with the user through the dialogue engine 106. Dialogue engine 106 is further capable of switching domains and use-cases by recognising new intents/use-cases/domains by the user during a conversation and also, adding remarks for previously generated switch suggestions.

Dialogue engine 106 further connects to NLU module 107 and switch suggestion module 108. NLU module 107 receives input from dialogue engine 106 and translates the natural language input into machine-readable information. NLU module 107 determines and generates transcribed context, intent, use-cases, entities, and metadata of the conversation with the user 101. The NLU module 107 uses natural language processing to determine use-case from the user's conversational input. Switch suggestion module 108 determines and generates as output, a use-case threshold score and the use-case switch suggestion based on the use-case threshold score. The use-case threshold may be determined automatically. Switch suggestion module 108 is also capable of generating a score associated with a use-case corresponding to an active domain in a conversation. For example, switch suggestion module 108 determines a first use-case in the user to system 100 conversation and assign a first use-case score to the first use-case. Then switch suggestion module 108 determines a second use-case in the user to system 100 conversation and assign a second use-case score to the second use-case.

The score of a use-case indicates a degree of confidence (e.g. a probability or other degree of likelihood) that the purpose of a conversation between user 101 and dialogue engine 106 satisfies an intent of the user 101. Switch suggestion module 108 may initiate a use-case switch suggestion, or refrain from initiating a use-case switch suggestion in a conversation depending on whether the score of the use-case satisfies a predetermined use-case score threshold. For example, if a score of a use-case is less than the predetermined use-case score threshold (e.g., 50%), switch suggestion module 108 refrains from initiating a use-case switch suggestion based on the use-case. If the use-case score exceeds or satisfies the predetermined use-case score threshold, switch suggestion module 108 initiates a use-case switch suggestion based on the use-case.

A Venn diagram or other techniques may be used to define or visualize the levels for switching in a conversation between a user and the system 100. FIG. 1C illustrates using a Venn diagram for this purpose. The set S 161 denotes the domain of a conversation. According to an example embodiment of the present invention, a domain may represent a content area of the conversation such as search, banking, shopping, movie, music, restaurant, flights, etc.

The set T 162 denotes the use-case of the conversation. According to an example embodiment of the present invention, a use-case may represent the interactions and activities associated with the domain to satisfy an intent. Examples of use-cases include, but are not limited to, in an active domain of banking, activities and interactions between a user and the system 100 corresponding to transferring money to an account, paying off credit card debt, or updating credentials etc.

The set U 163 denotes the intent of the conversation. According to an example embodiment of the present invention, an intent represents the action or purpose the user wishes to accomplish through participating in a conversation with system 100. Examples of intents include, but are not limited to user requests to initiate actions, find content, start over a process, go back, and find information, etc. An example of an intent to initiate an action includes, a user making a request to transfer money from his/her account within a corresponding use-case.

The set 164 includes the three sets i.e. set U 163, set T 162 and set S 161. The set 164 denotes the overlapping nature of set U 163 on set T 162, and set U 163 together with set T 162 on set S 161. Set 164 represents the various levels system 100 is capable of initiating and executing the switch during an on-going conversation. Set 164 further denotes that, the intent denoted by set U 163 is a subset of the use-case set T 162, which represents that an intent is a part and, for the present invention, the key point or ultimate goal of a use-case. Furthermore, set 164 denotes that set U 163 and set T 162 i.e. the intent and use-case together is a subset of set S 161, which represents that the intent and the use-case are domain-specific.

In an exemplary scenario, user 101 is in the middle of a conversation with system 100 in an active “banking” domain and a use-case of ‘transferring money’ to an account. The user 101 may then suddenly shift to an entirely different use-case such as, ‘beneficiary management’ for the self-account. Switching suggestion module 108 then recognizes the confidence score for the use-case of ‘beneficiary management’ to have crossed the predetermined threshold and/or has the highest confidence score amongst other identified use-cases' corresponding confidence scores. Switch suggestion module 108 may then initiate a use-case switch suggestion based on the use-case of ‘beneficiary management’ to user 101 through dialogue engine 106.

For the present invention, switch suggestion module 108 is further capable of initiating a domain switch suggestion in a conversation with the user 101 if the determined score for a domain is the highest and/or greater than or equal to a predetermined scoring threshold for domains. For example, the user 101 in the middle of a conversation with system 100 in the active “banking” domain and under the use-case of ‘transferring money’ may suddenly shift to an entirely different domain such as ‘bicycle configuration’. Switching suggestion module 108 then recognizes the confidence score for the ‘bicycle configuration’ domain to have crossed the predetermined threshold and/or has the highest confidence score amongst other confidence scores corresponding to a plurality of identified domains. Switch suggestion module 108 may then initiate a domain switch suggestion based on the ‘bicycle configuration’ domain to user 101 through dialogue engine 106.

For the present invention, switch suggestion module 108 is capable of switching between various levels in a conversation with a user. For example, the user 101 in the middle of a conversation with system 100 in the active domain regarding “banking” and the use-case corresponding to an intent of ‘transferring money’ may suddenly shift to an entirely different domain such as ‘bicycle configuration’ and then to a use-case corresponding to an intent of “purchasing a specific bicycle configurator’. Switching suggestion module 108 then recognizes the confidence score for each of the domains and the use-cases accordingly, and initiates a switch suggestion based on the highest confidence score to user 101 through dialogue engine 106.

In yet another embodiment of the present invention, the user model 109 connects to the dialog engine 106 and the switch suggestion module 108. User model 109 may include a data structure or other unit of data configured to store information about a user for providing personalized services. The user model 109 may include various information about a user such as user 101. For example, the user model 109 may include one or more identifiers for user 101 such as user IDs, user names, and other self-identifying information for the user. The user model 109 may also include user demographic information such as the user's age, gender, occupation, education information (e.g., education level, degrees etc.), or one or more locations associated with the user (e.g., the user's home, the user's places of work, places the user frequently visits, etc.). User model 109 may be generated over one or more interactions with user 101. For example, each time system 100 in FIG. 1A, interacts with user 101, system 100 may learn new information about user 101. System 100 may then store the new information in the user model 109 for use in future interactions. Therefore, the dialogue engine 106 and switch suggestion module 108 utilize the user model 109 to make determinations about a user based on the use-case of an active domain. The user's conversational input and the user's contextual characteristics are stored and retrieved remotely from at least one of a user model, a local storage medium, a web interface, an application programming interface (API) and a command line interface or a console.

According to yet another embodiment of the present invention, the system 100 provides personalized services to the user 101 based on the use-case of an active domain and the various user related information data stored in the user model 109.

Switch suggestion module 108 further connects to conversation history module 110. Conversation history module 110 stores data from past conversations associated with one or more users in system 100. The data includes various information, for example data associated with contextual characteristics that may help to improve domain/use-case/intent detection. The data from conversation history module 110 is used by switch suggestion module 108 to determine and generate a refined domain/use-case in order to further determine a more accurate intent of a user in a conversation. Switch suggestion module 108 is capable of providing a first intent and a second intent corresponding to a first use case and a second use case respectively; and wherein the first intent and the second intent are determined by analyzing the user's conversational input by the machine learning classifier 201.

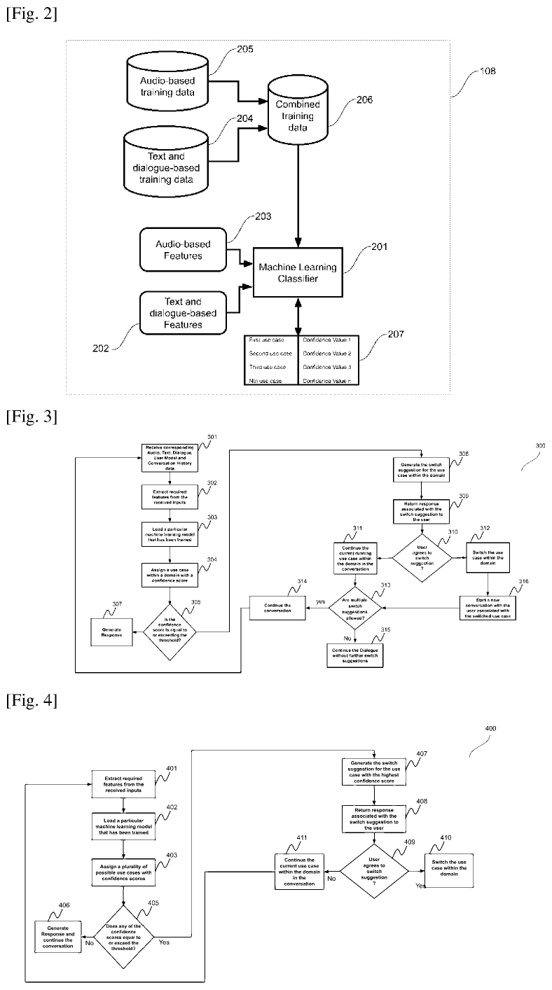

FIG. 2 is a detailed block diagram illustrating an exemplary switch suggestion module 108, in accordance with one or more aspects of the present invention. FIG. 2 includes switch suggestion module 108 as an example of switch suggestion module 108 of FIG. 1A.

Switch Suggestion Module 108 is described in detail below within the context of system 100 of FIG. 1A and includes a machine learning classifier 201 connected to a, a text and dialogue-based features module 202, an audio-based features module 203, a combined training data module 206, and confidence score module 207. Combined training data module 206 further connects to text and dialogue-based-training data module 204 and audio-based-training data module 205.

FIG. 2 illustrates only one particular example of Switch Suggestion Module 108, and many other examples of Switch Suggestion Module 108 may be used in other instances and may include a subset of the components included in the example. Switch Suggestion Module 108 may include additional components not shown in FIG. 2.

Switch Suggestion Module 108 is a module through which the system 100 determines whether to make a use-case switch suggestion from a first use-case to a second use-case during a conversation, between the user 101 and the system 100, based on relevant scores determined from information received through the audio and speech data. Switch suggestion module 108 is further capable of providing a first intent and a second intent corresponding to a first use case and a second use case respectively. The first intent and the second intent are determined by analyzing the user's conversational input by the machine learning classifier 201.

Switch suggestion module 108 is also capable of initiating a domain switch suggestion in a conversation with the user 101 if the score for a domain is determined to be the highest and/or greater than or equal to a predetermined scoring threshold for use cases.

Referring back to FIG. 2, the machine learning classifier 201 uses the text and dialogue-based feature data from text and dialogue-based features module 202, alongside audio-based feature data from audio-based features module 203 and combined training data from combined training data module 206 in order to classify a plurality of use-cases and help determine and assign a confidence score for each of the use-cases. Though not illustrated herein, the machine learning classifier 201 of switch suggestion module 108 connects to the dialogue engine 106 of system 100 illustrated in FIG. 1A.

In yet another embodiment of the present invention, machine learning classifier 201 uses only the text and dialogue-based feature data and combined training data in order to classify a plurality of use-cases and help determine and assign a confidence score for each of the use-cases.

Text and dialogue-based features module 202 stores text and dialogue based feature data from user conversations including, for example Term Frequency Inverse Document Frequency (TF-IDF), Sentiment Analysis, Word Embeddings, user timeouts, recognition failures etc. Text and dialogue-based feature data may be extracted from the NLU module 107 and the conversation history module 110 illustrated in FIG. 1A by text and dialogue-based features module 202.

Audio-based Features module 203 stores audio-based feature data from user conversations received from audio feature extractor 105 including, for example waveform (Zero-Crossings, Extremes), Root Mean Square Energy, Mel-Frequency Cepstral Coefficients (MFCC), Pitch, etc. Audio-based feature data from audio-based features module 203 of a last user input such as user 101 and from previous users inputs (if available) are received by machine classifier 201. Machine learning classifier 201 uses the data in order to help determine a confidence score for a use-case switch suggestion and predict the user's intent.

Combined training data 206 receives training data from text and dialogue-based-training data module 204 and audio-based-training data module 205 in order to define use-cases that, if correlated with particular use-cases in an active domain, may indicate a specific intent of the user 101 in a conversation with system 100. The training data may further be used to build a statistical model or policy to train the dialog engine 106.

Machine learning classifier 201 analyzes the combined training data from combined training data 206 and may employ deep learning on the information received from the data to train, develop and update machine learning models to predict actions and therefore, intents related to service, queries and contexts. Machine learning classifier 201 determines the relevant context to use from conversational inputs from a user.

Machine learning classifier 201 maps for each of the use-cases, their corresponding confidence scores as shown in the confidence score module 207. In this example, confidence score module 207 represents a plurality of use-cases and their corresponding confidence scores. The machine learning classifier 201 analyzes the user's conversational input to determine the first use-case and the second use-case from the plurality of use-cases. The machine learning classifier 201 then determines, based on the confidence scores, whether to initiate a use-case switch suggestion from a first use-case to a second use-case from a plurality of use-cases in an active domain to a user, such as user 101, during a conversation. The confidence scores may provide a numerical measure for a plurality of concepts, including, for example conversation alignment, balance, and emphasis etc.

FIG. 3 is a flowchart illustrating steps to predict and score a use-case in order to perform a use-case switch suggestion in a human-computer conversation, in accordance with one or more aspects of the present disclosure.

FIG. 3 describes below a method for predicting and executing a switch suggestion, when necessary, in the context of system 100 of FIG. 1A and switch suggestion module 108 of FIG. 2. For example, switch suggestion module 108 further performs the steps 301 to step 316 for predicting and executing a switch suggestion, when necessary, in accordance with one or more aspects of the present invention. At step 301, when a user 101 calls and begins interacting with system 100, corresponding data associated with audio, text, dialogue, user model and conversation history are transmitted to and received by switch suggestion module 108.

In the next step at step 302, machine learning classifier 201 of switch suggestion module 108 extracts relevant feature data from the received data that may define a use-case.

In the next step at step 303, machine learning classifier 201 of switch suggestion module 108 loads a machine learning model. The machine learning may be trained earlier utilizing relevant training data received from combined training data store 206. The machine learning model may be used to determine, predict and score one or more use-cases that may be identified in a running use case in a conversation with user 101.

In the next step at step 304, machine learning classifier 201 predicts an intent and scores a use-case which is identified in an active domain in a conversation with user 101. The use-case is then assigned with a confidence score as illustrated in FIG. 2.

In the next step at step 305, machine learning classifier 201 determines if the received use-cases corresponding confidence score satisfies or exceeds a minimum scoring threshold. Switch suggestion module 108 then provides the dialogue engine 106 with information whether a use-case switch suggestion should be sent in response to the user 101. For example, if the confidence score of a use-case is less than the minimum scoring threshold (e.g., 50%), switch suggestion module 108 may refrain from initiating a use-case switch suggestion based on the users 101 intent. If the score is greater than or equal to the minimum scoring threshold, switch suggestion module 108 may initiate a use-case switch suggestion based on the users 101 intent. The minimum scoring threshold may be predetermined automatically or by an administrator of system 100.

In yet another embodiment of the present invention, at step 305, the dialogue engine 106 determines if the received use-cases corresponding confidence score satisfies or exceeds a minimum scoring threshold and whether to initiate a use-case switch suggestion to the user based on the use-cases confidence score.

In the next step at step 307, if the use-cases corresponding confidence score is determined to not satisfy or exceed a minimum scoring threshold, dialogue engine then 106 generates a response for user 101 to stay associated with the prior use-case in the active domain within the conversation. Switch suggestion module 108 106 may further confirm not to generate a use-case switch suggestion.

In the next step at step 308, if the received use-cases corresponding confidence score satisfies or exceeds a minimum scoring threshold, dialogue engine 106 generates a use-case switch suggestion for response to user 101.

In the next step at step 309, dialogue engine 106 sends a response to user 101 associated with the use-case switch suggestion for the identified use-case exceeding the threshold.

In the next step at step 310, user 101 is required to confirm dialogue engine 106 whether the user agrees or disagrees with the use-case switch suggestion. The dialogue engine 106 is capable of performing a use-case switch from a first use-case to a second use-case, based upon an approval from the user in the conversation. The approval includes requesting the user for a confirmation with respect to the use-case switch.

In the next step at step 311, if user 101 disagrees to the use-case switch suggestion, the dialogue engine 106 then continues the conversation with user 101 associated with the prior use-case in the active domain.

In the next step at step 313, dialogue engine 106 determines if process 300 allows more than one use-case switch suggestion in an active domain within a conversation with user 101.

In the next step at step 314, dialogue engine 106 determines further use-case switch suggestions are allowed by process 300, if identified by switch suggestion module 108 in the active domain within the conversation with user 101. Dialogue engine 106 then keeps continuing the conversation with user 101 and steps 301 to 310 are then repeated for the conversation with user 101.

In the next step at step 315, dialogue engine 106 determines that more than one use-case switch suggestion is not allowed in an active domain within a conversation with user 101. Dialogue engine 106 then continues the conversation with user 101 without any further use-case switch suggestions.

In the next step at step 312, user 101 agrees to the use-case switch suggestion. Dialogue engine 106 then switches the use-case in the active domain with the conversation to the use-case user 101 has agreed.

In the next step at step 316, after the use-case switch, dialogue engine 106 starts a new conversation with user 101 associated to the use-case user 101 has agreed to. Machine learning classifier 201 resets the configuration features for the use-case in the active domain within a new conversation with user 101.

The dialogue engine 106 determines if further use-case switch suggestions are allowed by process 300, if identified by switch suggestion module 108 in the active domain within the new conversation with user 101. If allowed, the dialogue engine 106 then keeps continuing the conversation with user 101 and steps 301 to 310 are then repeated for the conversation with user 101.

If dialogue engine 106 determines that more than one use-case switch suggestion is not allowed in the active domain within the new conversation with user 101, dialogue engine 106 then continues the conversation with user 101 without any further use-case switch suggestions.

FIG. 4 is a flowchart illustrating the method of predicting and scoring a plurality of use-cases in order to perform a use-case switch suggestion in a human-computer conversation, in accordance with one or more aspects of the present disclosure.

FIG. 4 is described below in the context of system 100 of FIG. 1A and switch suggestion module 108 of FIG. 2. For example, switch suggestion module 108 further performs the steps 401 to step 411 for predicting and executing a switch suggestion, when necessary, in accordance with one or more aspects of the present invention.

At step 401, extracted features may include, for example data associated with audio, text, dialogue, user model and conversation history transmitted to and received by machine learning classifier 201 of switch suggestion module 108.

In the next step at step 402, machine learning classifier 201 of switch suggestion module 108 loads a machine learning model. The machine learning model is used to determine and score a plurality of use-cases that may be identified in a running use case in a conversation with user 101.

In the next step at step 403, machine learning classifier 201 predicts one or more intents and scores a plurality of use-cases that is identified in an active domain within a conversation with user 101. The plurality of use-cases are assigned with confidence scores as illustrated in FIG. 2. For example, the first use-case and the second use-case may be selected from a plurality of use-cases identified during the conversation.

In the next step at step 405, machine learning classifier 201 determines the plurality of use-cases along with their corresponding confidence scores and may predict a new possible intent. Machine learning classifier 201 then determines if any of the plurality of the received use-cases' corresponding confidence score satisfies or exceeds a minimum scoring threshold.

In yet another embodiment, at step 405, dialogue engine 106 may be used to determine if any of the plurality of confidence scores received for corresponding use-cases satisfies or exceeds the minimum threshold score. Dialogue engine 106 may then determine whether a use-case switch suggestion should be sent in response to user 101.

In the next step at step 406, if determined that none of the plurality of use-cases corresponding confidence scores satisfy or exceed the minimum scoring threshold, switch suggestion module 108 may confirm to not generate a use-case switch suggestion. The dialogue engine 106 then continues the conversation with user 101 associated with the prior use-case in the active domain if a use-case switch suggestion is not initiated from the switch suggestion module 108.

In the next step at step 407, if any of the plurality of received use-cases corresponding confidence score satisfies or exceeds the minimum scoring threshold, a use-case switch suggestion is determined and initiated. The dialogue engine 106 then generates a use-case switch suggestion for the use-case with the highest confidence score and/or exceeding the minimum scoring threshold for response to user 101.

In the next step at step 408, dialogue engine 106 sends a response to user 101 associated with the use-case switch suggestion for the identified use-case with the highest score and/or exceeding the threshold.

In the next step at step 411, if user 101 disagrees to the use-case switch suggestion. Dialogue engine 106 then continues the conversation with user 101 associated with the prior use-case in the active domain within the conversation.

In the next step at step 410, if the user 101 agrees with the switch suggestion, the use case switch is executed. Dialogue engine 106 then switches the use-case in the active domain to the use-case associated with the highest confidence score and further, the user 101 has agreed to.

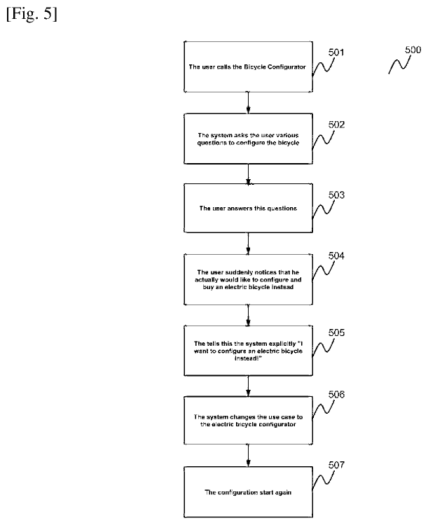

FIG. 5 is a flowchart illustrating an exemplary scenario for a process 500 performed by an example computing system configured for a user triggered use-case switch.

FIG. 5 is described below in the context of system 100 of FIG. 1A.

At step 501, a user 101 calls system 100 through communication control module 104 with queries regarding a specific use-case, such as a bicycle configurator for example. In the next step at step 502, dialogue engine 106 asks user 101 questions clarifying one or more aspects of the specific request related to the use-case, such as asking for missing information regarding the bicycle configurator in order to gather relevant data to guide user 101. In the next step at step 503, user 101 answers the questions asked by the dialogue engine 106. In the next step at step 504, user 101 changes his mind about the prior request about the use-case related to the bicycle configurator and realizes he may have queries about a second use-case which may be about buying and configuring an electric bicycle instead, for example. In the next step at step 505, user 101 explicitly voices his command to the dialogue engine 106 that he wants to buy and configure an electric bicycle instead. In the next step at step 506, the dialogue engine 106 then switches the use-case to electric bicycle configurator from bicycle configurator and guides user 101 accordingly with relevant data. In the next step at step 507, the configuration restarts for the newly generated use-case.

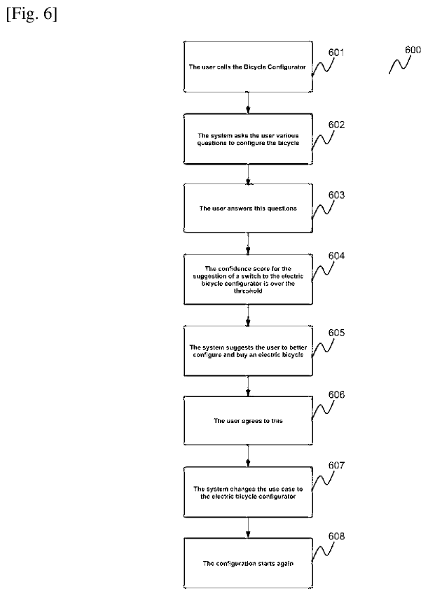

FIG. 6 is a flowchart illustrating an exemplary scenario for a process 600 performed by an example computing system configured for a system triggered use-case switch.

FIG. 6 is described below in the context of system 100 of FIG. 1A and switch suggestion module 108 of FIG. 2. Operations 601-608 are performed in a different order than that shown in FIG. 5 using additional or fewer operations than those shown.

At step 601, a user 101 calls system 100 through communication control module 104 with queries regarding a specific use-case, such as a bicycle configurator for example. In the next step at step 602, dialogue engine 106 asks user 101 questions clarifying one or more aspects of the specific request related to the use-case, such as asking for missing information regarding the bicycle configurator in order to gather relevant data to guide user 101. In the next step at step 603, user 101 answers the questions asked by the dialogue engine 106. In the next step at step 604, switch suggestion module 108 determines a confidence score corresponding to an electric bicycle configurator use-case to be the highest and s exceeding a minimum scoring threshold. The switch suggestion module 108 then initiates a use-case switch suggestion for the electric bicycle configurator use-case. In the next step at step 605, dialogue engine 106 sends a response to user 101 suggesting to better configure and buy an electric bicycle. In the next step at step 606, user 101 agrees to the suggestion made by dialogue engine 106. In the next step at step 607, dialogue engine 106 switches the use-case to electric bicycle configurator from bicycle configurator and guides user 101 accordingly with relevant data. In the next step at step 608, the configuration restarts for the newly generated use-case.

In yet another exemplary scenario of the present invention, in the middle of a conversation in a use-case in an active domain with a user, the dialogue engine 106 may be incapable of gathering needed information to satisfy the user's intent. For example, dialogue engine 106 may get bound to a situation in which either the user 101 is not providing the required information or the information provided is not comprehensible by the dialogue engine 106. Dialogue engine 106, in such a circumstance may suggest the user 101 to advance the conversation to a human agent. According to one embodiment of the present invention, in such a situation if the user agrees to the switch suggestion, for serving the intent, the user is rerouted to a human agent. The use-case in this situation is switched from the viewpoint of system 100 and not from the user's viewpoint because his intent remains the same. In this example, the use-case switch is seen from the system-side. According to an embodiment of the present invention, for the method of determining the updated use-case and providing a use-case switch suggestion in a human-computer conversation, the conversation takes place over a telecommunication network. Also, for the system (100) for determining an updated use-case and providing a use-case switch suggestion in a human-computer, the conversation takes place over a telecommunication network.

The system and method of determining an updated use-case and providing a use-case switch suggestion in a human-computer conversation according to the present invention includes use-cases pertaining to the services from at least one of primary sector services, secondary sector services and tertiary sector services, law services, banking or accounting services, restaurant services, health and fitness services, business and management services, medical/physical services, travel services, call center services, e-commerce services, educational services, transport services and government services.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

The embodiments and examples discussed herein are for the purpose of illustration of the invention only. It is apparent that numerous other forms of the invention may be envisaged by those skilled in the art without departing from the scope of the invention. The claims and embodiments are meant to cover all such forms and modifications that are within the scope of the claims and description of the embodiments should not be construed as limiting the scope of the description.

1. A method for determining an updated use-case and providing a use-case switch suggestion in a human-computer conversation, the method for determining the updated use-case and providing the use-case switch suggestion in the human-computer conversation comprises the steps of:
a. determining a first use-case in the human-computer conversation,
b. assigning a first use-case score to the said first use-case;
c. determining a second use-case in the human-computer conversation;
d. assigning a second use-case score to the said second use-case; and
e. determining whether to make the use-case switch suggestion to the said second use-case based on the said first use-case score and the said second use-case score.

2. The method of determining an updated use-case and providing a use-case switch suggestion in a human-computer conversation as claimed in claim 1, wherein the step of determining the use-case switch suggestion to said second use-case based on the said first use-case score and the said second use-case score further comprises the step of:
a. determining a use-case threshold score and the use-case switch suggestion being based on the use-case threshold score.

3. The method of determining an updated use-case and providing a use-case switch suggestion in a human-computer conversation as claimed in claim 1, further comprising:
a. initiating a use-case switch suggestion when the second use-case score satisfies or exceeds the predetermined threshold.

4. The method of determining an updated use-case and providing a use-case switch suggestion in a human-computer conversation as claimed in claim 1, wherein determining the first use-case and the second use-case comprises the steps of:
a. receiving, a user's conversational input; and
b. analyzing the user's conversational input utilizing a machine learning classifier.

5. The method of determining an updated use-case and providing a use-case switch suggestion in a human-computer conversation as claimed in claim 4, further comprising the step of providing a first intent and a second intent corresponding to the first use case and the second use case respectively wherein the first intent and the second intent are determined by analyzing the user's conversational input; and wherein for serving one of the intents, the user is rerouted to a human agent.

6. The method of determining an updated use-case and providing a use-case switch suggestion in a human-computer conversation as claimed in claim 1, further comprising the steps of:
a. performing a use-case switch from the first use-case to the second use-case, based upon an approval from the user in the conversation; wherein the approval includes requesting the user for a confirmation with respect to the use-case switch; and
b. resetting the machine learning classifier for a new use case, when a use-case switch is performed.

7. The method of determining an updated use-case and providing a use-case switch suggestion in a human-computer conversation as claimed in claim 1, wherein the first use-case and the second use-case are selected from a plurality of use-cases identified in the conversation; wherein the use-case score provides a numerical measure for a plurality of concepts, including at least one of conversation alignment, balance, and emphasis; and wherein the use-case score threshold is determined automatically.

8.-11. (canceled)

12. The method of determining an updated use-case and providing a use-case switch suggestion in a human-computer conversation as claimed in claim 1, wherein the user's conversational input and the user's contextual characteristics are stored and retrieved remotely from at least one of a user model, a local storage medium, a web interface, an application programming interface (API), a command line interface and a console.

13. The method of determining an updated use-case and providing a use-case switch suggestion in a human-computer conversation as claimed in claim 4, wherein the step of analyzing the user's conversational input further comprises the step of:
a. detecting voice activation;
b. detecting end/start-of-speech in a conversation; and
c. using natural language processing to determine use-case from the user's conversational input.

14. A system for determining an updated use-case and providing a use-case switch suggestion in a human-computer conversation, the system comprising:
a dialogue engine;
a natural language understanding module; and
a switch suggestion module, the switch suggestion module determines whether to make a use-case switch suggestion to a second use-case based on a first use-case score and a second use-case score.

15. The system of determining an updated use-case and providing a use-case switch suggestion in a human-computer conversation as claimed in claim 14, wherein the switch suggestion module determines a use-case threshold score and the use-case switch suggestion is based on the use-case threshold score; and wherein the use-case score threshold is determined automatically.

16. The system for determining an updated use-case and providing a use-case switch suggestion in a human-computer conversation as claimed in claim 14, wherein the switch suggestion module determines a first use-case in the human-computer conversation and assigns the first use-case score to the said first use-case; and determines a second use-case in the human-computer conversation and assigns the second use-case score to the said second use-case; and wherein the first use-case and the second use-case are selected from a plurality of use-cases identified during the conversation.

17. The system for determining an updated use-case and providing a use-case switch suggestion in a human-computer conversation as claimed in claim 16, wherein the dialogue engine receives a user's conversational input; and the switch suggestion module analyzes the user's conversational input using a machine learning classifier to determine the first use-case and the second use-case; and wherein the machine learning classifier is reset for a new use-case, when a use-case switch is performed.

18. The system of determining an updated use-case and providing a use-case switch suggestion in a human-computer conversation as claimed in claim 16, wherein the switch suggestion module is further capable of: providing a first intent and a second intent corresponding to the first use case and the second use case respectively; and wherein the first intent and the second intent are determined by analyzing the user's conversational input by the machine learning classifier; and wherein for serving at least one of the first intent and the second intent, the user is rerouted to a human agent.

19. The system for determining an updated use-case and providing a use-case switch suggestion in a human-computer conversation as claimed in claim 14, wherein the dialogue engine is capable of: performing a use-case switch from the first use-case to the second use-case, based upon an approval from the user in the conversation wherein the approval includes requesting the user for a confirmation with respect to the use-case switch.

20. (canceled)

21. The system for determining an updated use-case and providing a use-case switch suggestion in a human-computer conversation as claimed in claim 14, wherein the use-case score includes a numerical measure for a plurality of concepts, including at least one of: conversation alignment, balance, and emphasis; and wherein the use-case score is determined based on information received from the user's conversational input.

22.-25. (canceled)

26. The system for determining a use-case switch suggestion in a human-computer conversation as claimed in claim 14, wherein the user's conversational input and the user's contextual characteristics are stored and retrieved remotely from at least one of a user model, a local storage medium, a web interface, an application programming interface (API), a command line interface and a console.

27. The system of determining an updated use-case and providing a use-case switch suggestion in a human-computer conversation as claimed in claim 14, wherein the switch suggestion module analyzes the user's conversational input with the help of:
a communication control module and a natural language understanding module wherein the communication control module
a. detects voice activation;
b. detects end/start-of-speech in a conversation; and the natural language understanding module determines use-case from the user's conversational input.

28. The method of determining an updated use-case and providing a use-case switch suggestion in a human-computer conversation as claimed in claim 1, wherein the conversation takes place over a telecommunication network.

29. The system for determining an updated use-case and providing a use-case switch suggestion in a human-computer conversation as claimed in claim 14 wherein the conversation takes place over a telecommunication network.
